(19) United States
(12) Patent Application Publication
(10) Pub. No.: US 2024/0240654 A1
(43) Pub. Date: Jul. 18, 2024

(54) LOW NOISE ELECTRO-HYDRAULIC ACTUATOR

(71) Applicant: Parker-Hannifin Corporation, Cleveland, OH (US)

(72) Inventor: Karli R. ANDERSON, Big Lake, MN (US)

(73) Assignee: Parker-Hannifin Corporation, Cleveland, OH (US)

(21) Appl. No.: 18/530,733

(22) Filed: Dec. 6, 2023

Related U.S. Application Data
(60) Provisional application No. 63/480,018, filed on Jan. 16, 2023.
(60) Provisional application No. 63/515,453, filed on Jul. 25, 2023.

(51) Int. Cl. F15B 13/04; F15B 11/08; F15B 15/24

(52) U.S. Cl. CPC F15B 13/0401; F15B 11/08; F15B 15/24

(57) ABSTRACT

An electro-hydraulic actuator (EHA) comprising a pump, an electric motor drivingly coupled to the pump, and a piston-cylinder assembly having a piston and rod assembly axially movable within a cylinder. The cylinder has a piston-side cylinder chamber and a rod-side cylinder chamber that are each in fluid communication with the pump to effect movement of the piston and rod in response to fluid flow between the cylinder and the pump. The EHA further includes a check valve assembly arranged in a fluid line between the pump and the piston-side cylinder chamber and a flow restrictor in the fluid line between the piston-side cylinder chamber and the check valve assembly.

### RELATED APPLICATION

This application claims the benefit of U.S. Provisional Patent Application No. 63/480,018 filed on Jan. 16, 2023, and of U.S. Provisional Patent Application No. 63/515,453 filed on Jul. 25, 2023, the contents of which are incorporated herein by reference.

### TECHNICAL FIELD

The present invention relates generally to an electro-hydraulic actuator (EHA), and more particularly to low-noise electro-hydraulic actuator, such as for use with bariatric hospital beds.

### BACKGROUND

A typical electro-hydraulic actuator (EHA) includes an electric motor that drives a hydraulic pump to move fluid between a reservoir and a hydraulic actuator. The hydraulic actuator generally includes a tubular barrel in which a piston having a piston rod moves linearly, back and forth. The piston seals and separates the inside of the barrel into two chambers, an extend side fluid chamber and a retract side fluid chamber. The fluid chamber generally is filled with a substantially incompressible hydraulic fluid, typically an oil.

The pressure of hydraulic fluid pumped into or out of the fluid chambers moves the piston within the barrel. In general, when the electric motor is driven in a first rotational direction, the hydraulic pump moves the fluid into the fluid chamber of the hydraulic actuator and out of the piston chamber, thereby extending a piston rod from the actuator housing. When the electric motor is driven in a second rotational direction, opposite the first rotational direction, the hydraulic pump moves the hydraulic fluid out of the fluid chamber and into the piston chamber, thereby retracting the rod.

### SUMMARY

One exemplary use of an EHA is to raise or lower a bariatric hospital bed frame. When the bariatric bed frame is lowered by powering two EHAs simultaneously via pulse width modulation (PWM) control, the pump flow can be reduced by up to 70%. If a high compressive load is applied to the actuator as it retracts, the pump may not be able to provide enough flow to keep the extend side pilot operated check valve open to allow fluid from the piston side back to the tank. This results in an unstable oscillating spool that emits excessive vibration and resonating sound greater than 70 dB.

An aspect of the present disclosure solves one or more problems of the conventional EHAs by adding a fixed orifice restrictor in a fluid line between the extend side fluid chamber and a check valve, thereby reducing the pressure closing the extend side check valve. This allows the pump to keep the spool valve shifted as it opens the extend side check valve that allows the fluid to flow back to the tank. In such a use case as a bariatric hospital bed, this enables improved stabilization as the bed raises and lowers and emits minimal to no sound or excessive vibration.

At least one aspect of the present disclosure provides an electro-hydraulic actuator (EHA) comprising: a pump; an electric motor drivingly coupled to the pump; a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump; a check valve assembly arranged in a fluid line between the pump and the piston-side cylinder chamber; and a flow restrictor in the fluid line between the piston-side cylinder chamber and the check valve assembly.

According to an aspect of the disclosure, a structure comprising a raisable and lowerable support and at least a first and a second electro-hydraulic actuators (EHA): the first and second EHA each comprising: a pump; an electric motor drivingly coupled to the pump; a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump; a check valve assembly arranged in a fluid line between the pump and the piston-side cylinder chamber; and a flow restrictor in the fluid line between the piston-side cylinder chamber and the check valve assembly, wherein the first EHA is positioned at a first end of the support, wherein the second EHA is positioned at a second end of the support that is opposite the first end.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

FIG. 1 illustrates an exemplary electro-hydraulic actuator (EHA) according to the present disclosure.

FIG. 2 illustrates the EHA of FIG. 1 in cross-section.

FIG. 3 illustrates an exemplary valve arrangement of an EHA according to the present disclosure in cross-section.

FIG. 4 illustrates the valve arrangement of FIG. 3 in a rod retraction operation in cross-section.

FIG. 5 illustrates the check seat of the valve arrangement of FIG. 3 in isolation.

FIG. 6 illustrates a check seat of a check-valve assembly of an EHA according to the present disclosure in isolation.

FIG. 7 illustrates a retainer of a check-valve assembly of an EHA according to the present disclosure in isolation.

FIG. 8 illustrates an exemplary support surface including a plurality of EHAs to raise and lower the support surface according to the present disclosure.

FIG. 9 illustrates a hydraulic schematic of an exemplary EHA.

### DETAILED DESCRIPTION

Aspects of the present disclosure pertain to a low-noise electro-hydraulic actuator (EHA) for use with support surfaces are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Disclosed is an electro-hydraulic actuator (EHA) that includes a fixed orifice restrictor to limit or reduce noise and/or vibrations of at least one check valve during operation of the EHA. As noted above, conventionally, the flow from the pump in the EHA is sufficient to move a spool to open a retract side check valve in the EHA to permit fluid flow through the check valve. However, when a compressive load is applied to the actuator as it retracts, the flow of fluid leaving the extend side of the actuator (also referred to as the piston side) is high enough that it overcomes the force from the spool and closes the check valve. Accordingly, the low-noise EHA described herein includes a fixed orifice restrictor that limits or meters the flow of hydraulic fluid prior to the check valve of the EHA to reduce fluid pressure on the check valve.

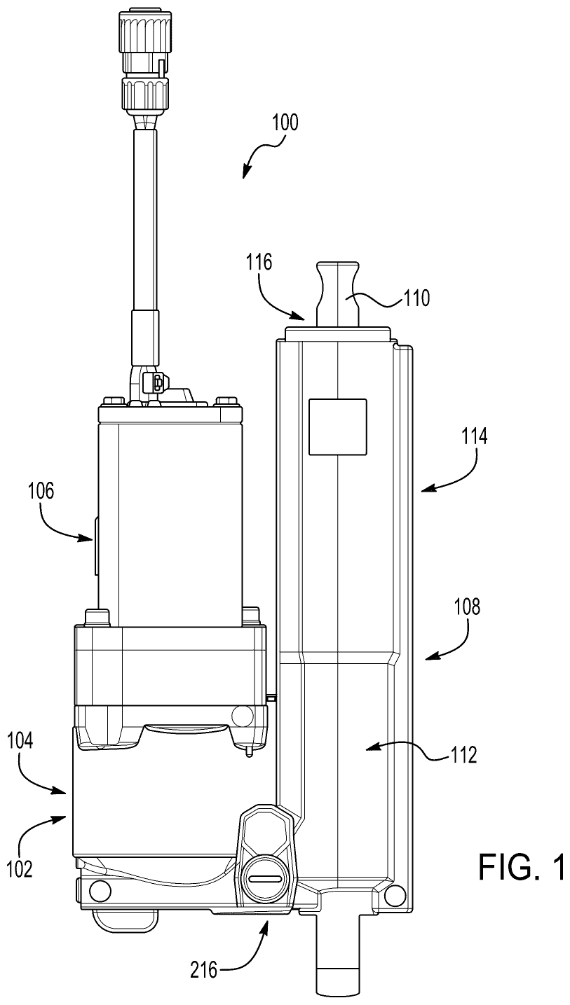

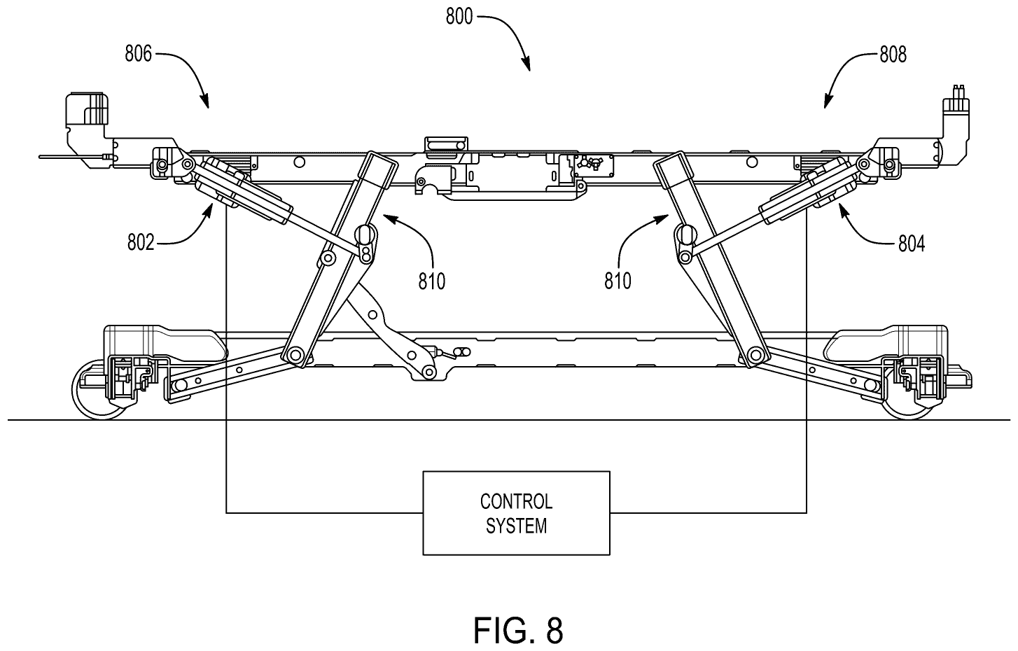

Turning now to FIG. 1, illustrated is an exemplary electro-hydraulic actuator (EHA) 100 configured for low-noise use to move a support surface (e.g., bariatric hospital bed 800, FIG. 8). The EHA 100 includes a fluid reservoir 102, a pump 104 for moving fluid, a motor 106 drivingly coupled to the pump 104, and a piston-cylinder actuator assembly 108 that includes a rod 110 that moves axially in and out of a cylinder 112 based on the motor 106 moving the fluid in the fluid reservoir 102. Accordingly, the piston-cylinder actuator assembly 108 is in fluid communication with the pump 104 to effect movement of the rod 110 in response to fluid flow between the cylinder 112 and the pump 104. Any suitable fluid can be used to move the rod 110 and different fluids may be used for different scenarios. In the embodiments described herein, the fluid is an incompressible liquid, more particularly a hydraulic fluid.

The EHA 100 can further include a housing 114 that retains the fluid reservoir 102, the pump 104, the motor 106, and/or the piston-cylinder actuator assembly 108 in entirety or portions thereof. Moreover, the same housing 114 can be used for multiple components and/or different housings can be used for different components that are then linked together as desired. In the illustrated embodiment, a singular housing 114 surrounds and seals within the fluid reservoir 102, the pump 104, and the motor 106 while including an aperture 116 that permits the rod 110 to travel in and out of the housing 114.

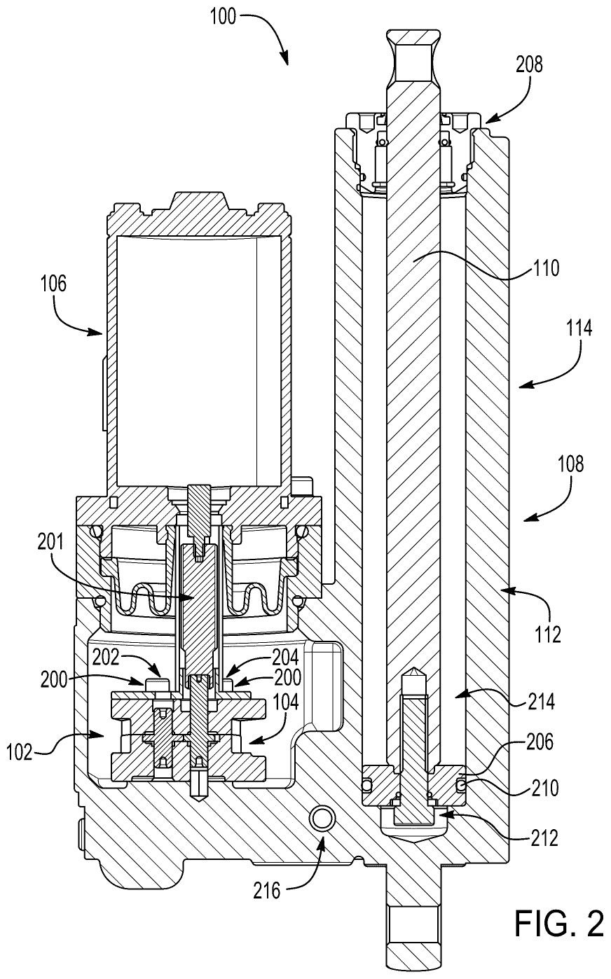

Turning now to FIG. 2, illustrated is a cross-sectional view of the EHA 100 from FIG. 1. The pump 104 may be any suitable pump, such as a gerotor pump. In the illustrated embodiment, the pump 104 is located within the fluid reservoir 102. In another embodiment, the pump 104 is mounted to an interior of the housing 114 outside the fluid reservoir 102. The fluid reservoir 102 generally includes a volume of hydraulic fluid such that when the rod 110 is fully extended, the volume of hydraulic fluid in the fluid reservoir 102 is at a minimum. The EHA 100 can further include at least one inlet/out port 200 that is connected to a fluid line between the cylinder 112 and the fluid reservoir 102 and is further positioned to be submerged in the hydraulic fluid in the fluid reservoir 102. In a dual-acting system, the EHA 100 may include two inlet/outlet ports 200 with corresponding fluid lines where one fluid and the corresponding inlet/outlet port 200 is connected to an extend (piston) side of cylinder 112 and the other fluid line and the corresponding inlet/outlet port 200 is connected to the retract (rod) side of the cylinder 112.

The EHA 100 can further include a coupling 201 that connects the motor 106 to the pump 104 such that movement of the motor 106 causes a corresponding movement of the pump 104. Any suitable coupling 201 may be used and in the illustrated embodiment, the coupling 201 is a drive shaft.

The pump 104 and/or the motor 106 may be reversible, whereby reversing the motor 106 reverses the direction in which the pump 104 moves the hydraulic fluid. When the pump 104 is moving the hydraulic fluid from the reservoir 102 to the cylinder 112, the at least one port 200 acts as an inlet or intake port. When the hydraulic fluid is moving from the cylinder 112 to the reservoir 102 (via direct or indirect action of the pump 104), the at least one port 200 acts as an outlet port. In the illustrated embodiment, the ports 200 are configured to function as both inlet ports and outlet ports. However, it is conceivable that the EHA 100 can include separate inlet ports and outlet ports, i.e., a first port is configured solely as an inlet port and a second port is configured solely as an outlet port. The EHA 100 can include any suitable number of ports 200 and the ports 200 may be similar and/or can vary. In the illustrated embodiment, the EHA 100 includes two inlet/outlet ports 200 that act as inlet/outlet ports for the first fluid line connected to the piston side of the cylinder 112 and the second fluid line connected to the rod side of the cylinder 112.

As seen in the illustrated embodiment, the piston-cylinder actuator assembly 108 includes a piston 206 movably positioned within the cylinder 112. In the illustrated embodiment, the cylinder 112 is formed by the housing 114, but the cylinder 112 may be formed as a separate component that is then inserted into the housing 114 and/or attached to the housing 114. The rod 110 is attached to the piston 206 (e.g., via a machine thread or the like) to extend from the piston 206 such that movement of the piston 206 in the cylinder 112 drives the rod 110 in and out of the cylinder 112 at a cylinder head 208 of the cylinder 112. In the illustrated embodiment, the rod 110 extends from a single side of the piston 206, but the piston-cylinder actuator assembly 108 may include rods extending from opposite ends of the piston 206 and out both ends of the cylinder 112.

The piston 206 includes a seal 210 around an outer surface of the piston 206 configured to engage an interior wall of the cylinder 112 to fluidly separate pressure zones within the cylinder 112 on opposing sides of the piston 206. In the illustrated embodiment, the EHA 100 includes a piston-side cylinder chamber 212 (also referred to as an extend side chamber) on a side of the piston 206 without the rod 110, and a rod-side cylinder chamber 214 (also referred to as a retract side chamber) on a side of the piston 206 with the rod 110. The first inlet/outlet port 202 can act as an inlet/outlet for a first fluid line between the reservoir 102 and the rod-side cylinder chamber 214 while the second inlet/outlet port 204 can act as an inlet/outlet for a second fluid line between the reservoir 102 and the piston-side cylinder chamber 212. Accordingly, the pump 104 can be used to pump hydraulic fluid from the reservoir 102 into the piston-side cylinder chamber 212 to move the piston 206 to extend the rod 110 out of the cylinder 112 and/or from the reservoir 102 into the rod-side cylinder chamber 214 to move the piston 206 to retract the rod 110 into the cylinder 112.

To move the piston 206 in the cylinder 112 to extend and/or retract the rod 110, the hydraulic fluid can be pumped into the cylinder 112 on a first side of the piston 206 while also being evacuated from the cylinder 112 on an opposite second side of the piston 206. More particularly, as hydraulic fluid is pumped into the piston-side cylinder chamber 212 to extend the rod 110 out of the cylinder 112, hydraulic fluid in the rod-side cylinder chamber 214 needs to be evacuated. Similarly, as hydraulic fluid is pumped into the rod-side cylinder chamber 214 to retract the rod 110 into the cylinder 112, hydraulic fluid in the piston-side cylinder chamber 212 need to be evacuated. The hydraulic fluid may be evacuated from the cylinder 112 via any suitable set-up. In the embodiments of the EHA 100 illustrated herein, the movement of the piston 206 caused by pumping the hydraulic fluid into a first chamber (e.g., the piston-side cylinder chamber 212) on a first side of the piston 206 pushes the hydraulic fluid in the opposing second chamber (e.g., the rod-side cylinder chamber 214) on the second side of the piston 206 out of the cylinder 112.

Due to the differential volume of hydraulic fluid in the cylinder 112 between extended and retracted states of the rod 110, a pocket of air (or other compressible gas) may be located inside the housing 114 to accommodate the varying volumes of hydraulic fluid in the fluid reservoir 102. For instance, as the rod 110 moves from a fully extended position to a fully retracted position, the volume of the compressible gas within the housing 114 is compressed. Similarly, as the rod 110 moves from the fully retracted position to the fully extended position, the volume of the compressible gas in the housing 114 expands and the fluid reservoir 102 pressure decreases. Generally, the pump inlet/outlet port(s) 200 should be submerged in the hydraulic fluid to avoid exposure to the pocket of compressible gas. Exposing the inlet/outlet port 200 to the pocket of compressible gas could result in the pump 104 introducing the compressible gas into the hydraulic circuit, which can lead to compressibility in the cylinder 112.

To prevent hydraulic fluid being pumped into and/or evacuated from the cylinder 112 from co-mingling outside of the fluid reservoir 102, the first fluid line between the first inlet/outlet port 202 and the piston-side cylinder chamber 212 is fluidly separate from the second fluid line between the second inlet/outlet port 204 and the rod-side cylinder chamber 214. Additionally, to prevent unintentional hydraulic fluid flow between the reservoir 102 and the cylinder 112, the first and/or second fluid lines can include one or more check-valve assemblies.

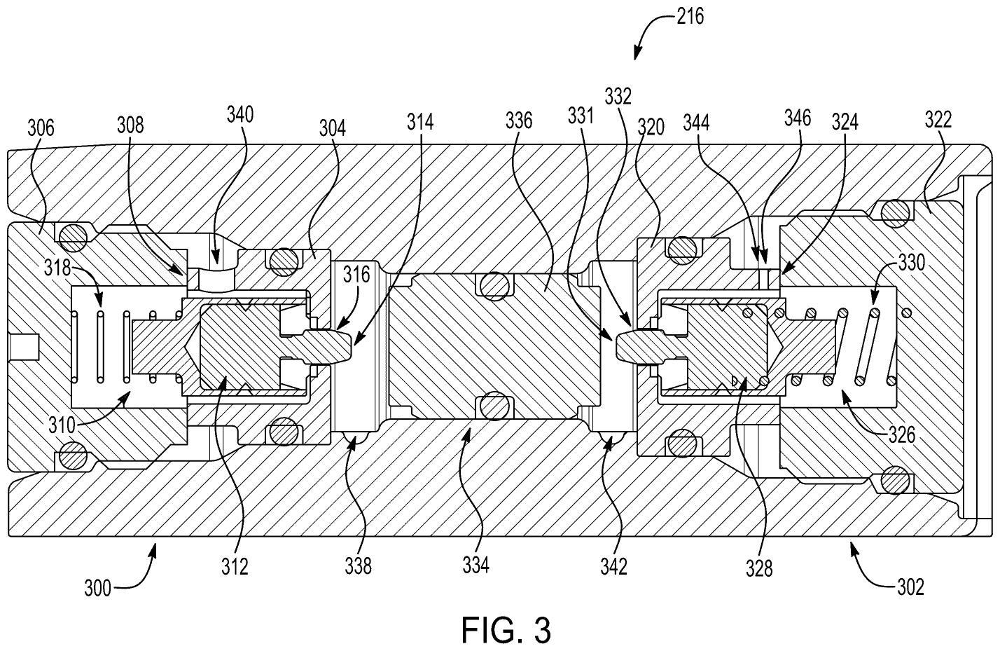

One or more of the check-valve assemblies can be a pilot-operated check-valve assembly that locks the corresponding fluid line in a neutral position and only in response to a pilot pressure does check-valve assembly open to permit fluid flow between the reservoir 102 and the cylinder 112. The pilot pressure can be supplied by any suitable source and, as described in detail below, the pilot pressure can be supplied by incoming hydraulic fluid from the pump 104 and/or the spool 336 (FIG. 3). Accordingly, each pilot-operated check-valve assembly can be movable between a closed position, which may be a neutral position and/or an active position, that prevents fluid flow therethrough to fluidly disconnect the reservoir 102 and the cylinder 112 and an open position that permits fluid flow therethrough to fluidly connect the reservoir 102 and the cylinder 112.

In the illustrated embodiment, the EHA 100 includes a valve arrangement 216 positioned in the housing 114 between the fluid reservoir 102 and the cylinder 112. However, one or more portions of the valve arrangement 216 can be positioned outside of the housing 114 and the corresponding fluid line(s) can extend outside the housing to reach the portion(s) of the valve arrangement 216 outside of the housing 112.

Turning now to FIG. 3, illustrated is a cross-sectional view of the valve arrangement 216 in isolation. In the illustrated embodiment, the valve arrangement 216 includes a first check-valve assembly 300 that is arranged in the first fluid line between the reservoir 102 and the rod-side cylinder chamber 214 and a second check-valve assembly 302 that is arranged in the second fluid line between the reservoir 102 and the piston-side cylinder chamber 212. The first check-valve assembly 300 includes a check seat 304 and a retainer 306 that are adjacent to each other and engage each other at an interface 308. The check seat 304 and the retainer 306 define an internal passage 310 that fluidly connects a first side of the first check-valve assembly 300 and a second side of the first check-valve assembly 300.

The first check-valve assembly 300 further includes a check valve 312 movably positioned within the internal passage 310. The check-valve 312 is movable between a closed position that prevents fluid flow through the internal passage 310 to fluidly separate the reservoir 102 and the cylinder 112 and an open position that permits fluid flow through the internal passage 310 to fluidly connect the reservoir 102 and the cylinder 112.

In the illustrated embodiment, the check valve 312 includes a nose 314 that sealingly engages the check seat 304 to seal an opening 316 at an end of the check seat 304. The check valve 312 is configured to move in and out of sealing the opening 316 to selectively prevent (sealed) and/or permit (unsealed) hydraulic fluid flow through the internal passage 310. In the illustrated embodiment, the check valve 312 is biased toward the sealing position via a biasing mechanism (e.g., a spring 318).

Similarly, the second check-valve assembly 302 includes a check seat 320 and retainer 322 engaging each other at an interface 324 to define an internal passage 326. A check valve 328 is movably positioned in the internal passage 326 and biased by a spring 330 to seal an opening 332 on an end of the check seat 320 via a nose 331 on the check valve 328.

The valve arrangement 216 can further include a shared fluid tube 334 that extends between the first check-valve assembly 300 and the second check-valve assembly 302. The valve arrangement 216 can yet further include a spool 336 movably positioned within the fluid tube 334 with a corresponding seal that fluidly separates a rod-side fluid path and a piston-side fluid path through the valve arrangement 216. The rod-side fluid path extends from a first port 338 in the fluid tube 334 in fluid communication with the first inlet/outlet port 202 and a first orifice 340 in the first check-valve assembly 300 in fluid communication with the rod-side chamber 214. Similarly, the piston-side fluid path extends from a second port 342 in the fluid tube 334 in fluid communication with the second inlet/outlet port 204 and a second orifice 344 in the second check-valve assembly 302 in fluid communication with the piston-side chamber 212.

In a first exemplary operation of the EHA 100, hydraulic fluid enters the fluid tube 334 at the first port 338 via action of the pump 104. As pressure of the hydraulic fluid builds between the spool 336 and the first check-valve assembly 300, the hydraulic fluid presses the check valve 312 against the spring 318 and when the fluid pressure overcomes the spring force, the check valve 312 is opened to open fluid communication between the first port 338 and the first orifice 340 of the first check-valve assembly 300. Accordingly, hydraulic fluid can flow between the reservoir 102 and the rod-side chamber 214.

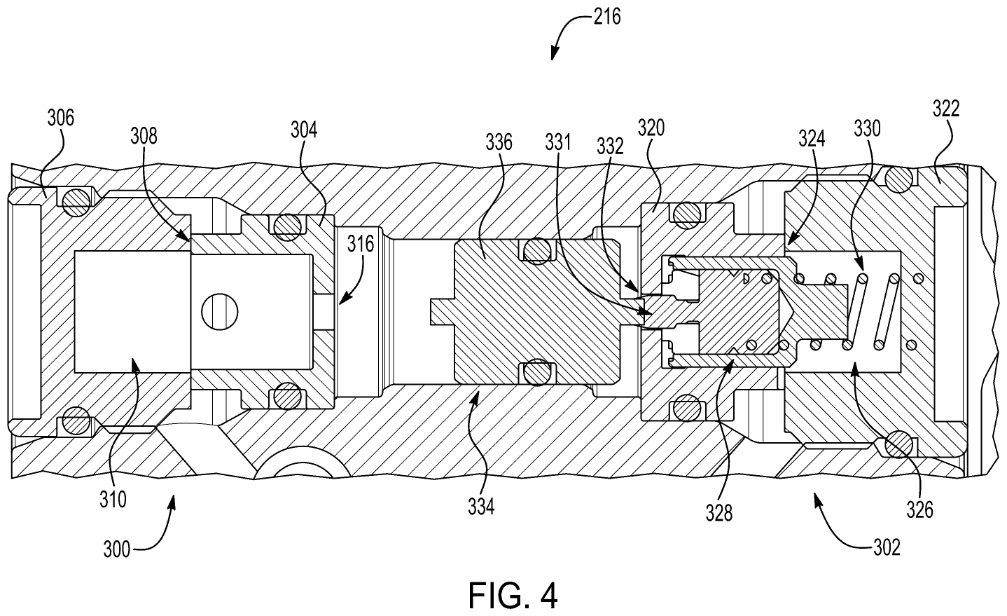

In addition to moving the check valve 312, the pressure of the hydraulic fluid between the spool 336 and the first check-vale assembly 300 further causes the spool 336 to move in the fluid tube 334 toward the second check-valve assembly 302. Because the check valve 328 of the second check-valve assembly 302 is biased toward the sealed position by the spring 330, the piston-side chamber 212 and the reservoir 102 are not in fluid communication. Accordingly, to evacuate hydraulic fluid in the piston-side chamber 212 to accommodate movement of the piston 206, the spool 336 is configured to engage the check valve 328 when moved by the hydraulic fluid to additionally move the check valve 328 out of the sealing position (as seen in FIG. 4). FIG. 4 illustrates another cross-sectional view of the valve arrangement 216 from another angle with the check valve 312 and the spring 318 of the first check valve-assembly 300 removed.

In another exemplary operation of the EHA 100, the above-described situation is switched, with hydraulic fluid being pumped into the fluid tube 334 at the second port 342. The hydraulic fluid now presses the check valve 328 of the second check-valve assembly 302 against the spring 330 to open fluid communication between the second port 342 and the second orifice 344. Similarly, the hydraulic fluid presses the spool 336 toward the first check-valve assembly 300 to press the check valve 312 against the spring 318 to open fluid communication between the first port 338 and the first orifice 340.

Therefore, the hydraulic fluid being pumped into the fluid tube 334 travels in a direction against the bias of the spring 318 and/or 330 which maintains the corresponding check-valve assembly 300 and/or 302 in the open position by nature of the flow of the hydraulic fluid. In contrast, the hydraulic fluid being evacuated from the cylinder flows through the respective check-valve assembly 300 and/or 302 in a direction along the bias of the corresponding spring 318 and/or 330 toward the sealing position. Accordingly, the EHA 100 utilizes the movement of the spool 336 to overcome both the bias of the spring and pressure of hydraulic fluid through the internal passage to maintain the respective check-valve assembly 300 and/or 302 in the open position. The operating speed of the pump 104 and/or motor 106 are sufficient to maintain pressure on the moved spool 336 to keep the check valve 312 and/or 328 in the open position to keep the corresponding fluid line open to continue evacuating hydraulic fluid from the cylinder 112. Therefore, the first orifice 340 of the first check-valve assembly 300 and the second orifice 344 of the second check-valve assembly 302 may be the same size.

In certain situations, the flow of the hydraulic fluid being pumped into the fluid tube 334 is not sufficient to overcome the flow of the hydraulic fluid being evacuated from the cylinder 112. For instance, a downward pressure on the rod 110 can cause hydraulic fluid being evacuated from the piston-side cylinder chamber 212 to have a fluid flow pressure through the second check-valve assembly 302 that overpowers pressure exerted on the spool 336 by the pumped hydraulic fluid, resulting in the check valve 328 closing the second fluid path preventing further fluid evacuation. The pressure of the pumped hydraulic fluid entering the fluid tube 334 can then build on the spool 336, driving the spool 336 toward the check valve 328 to again open the second fluid path, which can in turn result in hydraulic fluid evacuating the cylinder 112 to again move the check valve 328 to close the second fluid path. This oscillation of the check valve 328 and/or the spool 336 can result in the EHA 100 producing noise and/or vibrations that may be unpleasant as the rod 110 is retracted.

These noises and/or vibrations may be overcome by increasing the operating speed of the motor 106 or output of the pump 104 to compensate for the increased pressure of the hydraulic fluid evacuating the cylinder 112. However, there are situations where increasing the operating speed or output is not an option. For instance, where the EHA 100 is used on a bariatric hospital bed and/or similar support surface, increasing the operating speed can cause the EHA 100 to move the support surface at a potentially undesirable speed. Moreover, there may be situations where the operating speed and/or output cannot be increased because of mechanical constraints of the motor 106 or the pump 104, i.e., the motor 106 and pump 104 are already operating at full strength.

Accordingly, in the EHA 100 described herein, the second check-valve assembly 302 includes a fixed orifice restrictor 346 positioned between the cylinder 112 and the check valve 328 and configured to limit or restrict the rate hydraulic fluid evacuating the cylinder 112 enters the second check-valve assembly 302. By metering hydraulic fluid prior to the check valve 328, the fixed orifice restrictor 346 can create stability of the check valve 328 as opened by the spool 336.

The fixed orifice restrictor 346 can take any suitable shape, size, and/or configuration to restrict the rate of hydraulic fluid reaching the check valve 328. The shape and/or size of the fixed orifice restrictor 346 can be based on an average operating speed of the motor 106 during operation, an average output of the pump 104 during operation, and/or a predetermined maximum compressive load applied against the rod 110 during operation. For instance, an EHA with a first average operating speed of the motor 106 may have a first fixed orifice restrictor with a first cross-sectional area, whereas an EHA with a second average operating speed of the motor 106 that is higher than the first average operating speed may have a second fixed orifice restrictor with a second cross-sectional area that is larger than the first cross-sectional area.

The fixed orifice restrictor 346 can be located at any suitable location between the piston-side cylinder chamber 212 and the check valve 328 of the second check-valve assembly 302. For instance, the fixed orifice restrictor 346 may comprise one or more portions of flow tubing between the piston-side cylinder chamber 212 and the check valve 328 that are narrowed compared to other portions of the flow tubing. In the embodiment illustrated in FIG. 3, the fixed orifice restrictor 346 is a smaller cross-sectional area for the second orifice 344 compared to the cross-sectional area of the first orifice 340. The fixed orifice restrictor 346 can have a uniform cross-sectional shape and/or area along the length of the orifice restrictor 346, as illustrated, and/or the shape can vary, e.g., telescoping. In the illustrated embodiment, the fixed orifice restrictor 346 is created by machining a smaller hole in the side of the check seat 320 compared to a conventional size of the second orifice 344. In an exemplary embodiment, the fixed orifice restrictor 346 has a cross-sectional diameter in a range of 0.010 inches to 0.070 inches, more particularly 0.015 inches to 0.045 inches, even more particularly 0.020 inches to 0.030 inches, whereas a conventional second orifice 344 has a cross-sectional diameter of 0.090 inches. In the illustrated embodiment, the fixed orifice restrictor 346 has a cross-sectional diameter of 0.025 inches. In another exemplary embodiment, the fixed orifice restrictor 346 has a cross-sectional diameter that is a percentage smaller compared to the cross-sectional diameter of the conventional second orifice 344. The percentage can be in the range of 10% to 70%, more particularly 20% to 50%. For instance, the cross-sectional diameter of the fixed orifice restrictor 346 can be at least 23% smaller than the cross-sectional diameter of the conventional second orifice 344.

In another embodiment, the fixed orifice restrictor 346 is a separate component that is then placed in the fluid path between the piston-side cylinder chamber 212 and the check valve 328. For instance, the fixed orifice restrictor 346 may be an insert configured for insertion into a conventional second orifice 344 with a central passage that defines the narrower passage. In another example, the fixed orifice restrictor 346 may be a valve, such as a needle valve, that is attached to the second fluid line.

In the illustrated embodiment, the fixed orifice restrictor 346 is formed as an orifice extending through a side wall of the check seat 320 of the second check-valve assembly 302. By placing the fixed orifice restrictor 346 in the second check-valve assembly 302, the fixed orifice restrictor 346 may be used with a conventional EHA without requiring replacement of tubing.

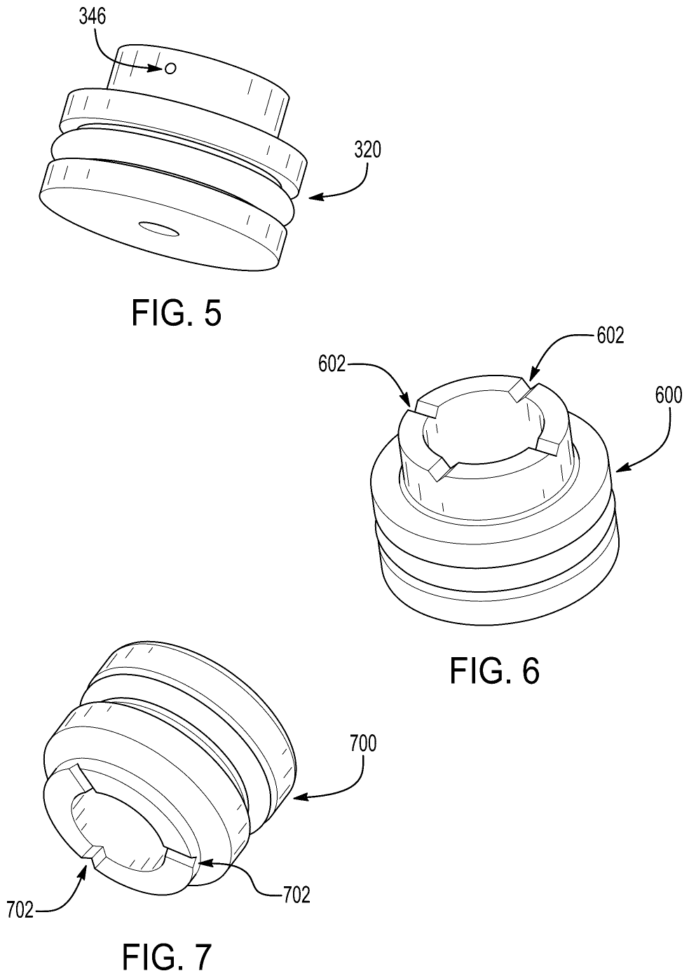

Turning now to FIG. 5, illustrated is the check seat 320 of the second check-valve assembly 302 in isolation. In the illustrated embodiment, the check seat 320 includes a single fixed orifice restrictor 346 formed in the side wall of the check seat 320. However, it is understood that the check seat 320 may include a plurality of fixed orifice restrictors spaced from each other in the side wall. The plurality of fixed orifice restrictors may have any suitable arrangement, such as equal circumferential spacing.

In the previously illustrated embodiments, the fixed orifice restrictor 346 is formed in the side wall of the check seat 320, however the fixed orifice restrictor 346 may be formed on other parts of the check seat 320 and/or the retainer 322. Illustrated in FIG. 6 is an exemplary check seat 600 where the fixed orifice restrictor 346 is one or more indents 602 formed on an end surface of the check seat 600 that engages the corresponding end surface of the retainer 322 at the interface 324. The corresponding end surface of the retainer 322 may be flat and/or may include one or more indents that correspond to the indents 602 on the check seat 600.

Illustrated in FIG. 7 is an exemplary retainer 700 where the fixed orifice restrictor 346 is one or more indents 702 formed on an end surface of the retainer 700 that engages the corresponding end surface of the check seat 320 at the interface 324. Similarly, the corresponding end surface of the check seat 320 may be flat and/or may include one or more indents that correspond to the indents 702 on the retainer 700.

As noted above, the EHA 100 described herein can be used to move a support surface. Illustrated in FIG. 8 is an embodiment of a bariatric hospital bed 800 where one or more portions of the bed 800 are raisable and lowerable using the above-described EHA 100. In the illustrated embodiment, the bed 800 includes a first EHA 802 and a second EHA 804 that are arranged at opposite ends of the bed 800. More particularly, the first EHA 802 is arranged at the head 806 of the bed 800 to raise and/or lower the head 806 and the second EHA 804 is arranged at the foot 808 of the bed 800 to raise and/or lower the foot 808. The bed 800 can further include other pivotable supporting structure 810 used to support the bed 800 as the different portions of the bed 800 are raised and/or lowered.

Both the first EHA 802 and the second EHA 804 can include the same or similar structure and/or may vary as desired. In one example, both the first EHA 802 and the second EHA 804 each include a fixed orifice restrictor (e.g., fixed orifice restrictor 346) positioned between a respective piston-side cylinder chamber and a check valve. The fixed orifice restrictor may be similar for both EHAs 802 and 804 and/or the fixed orifice restrictor may vary. For instance, the first EHA 802 may have a fixed orifice restrictor with a first cross-sectional area and the second EHA 804 may have a fixed orifice restrictor with a second cross-sectional area that is different from the first cross-sectional area. In another example, only one of the EHAs (e.g., the first EHA 802) includes a fixed orifice restrictor, while the other EHA (e.g., the second EHA 804) does not.

The bed 800 further includes a control system 812 in communication with the first EHA 802 and/or the second EHA 804. The control system 812 can be configured to control operation of the respective motor and/or pump of the connected EHA 802 and 804. For instance, the control system 812 can be configured to simultaneously operate the first EHA 802 and the second EHA 804 via pulse width modulation (PWM) control. Moreover, the control system 812 can be configured such that an operating speed of the motor of the first EHA 802 is a function of an operating speed of the motor of the second EHA 804, or vice-versa.

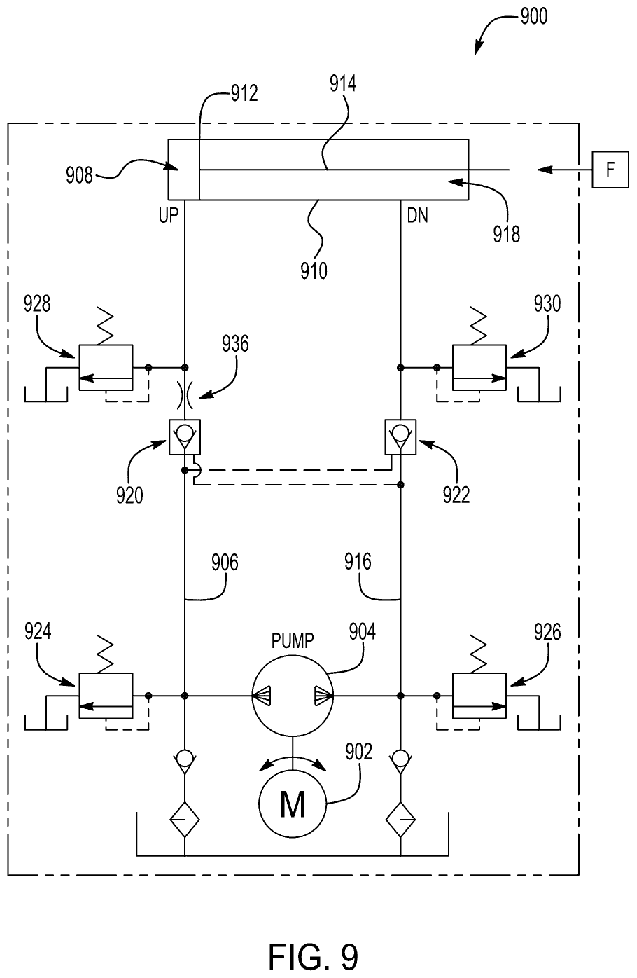

Turning now to FIG. 9, a hydraulic circuit diagram of an exemplary EHA 900 configured for use to move the support surface described above, is shown. The EHA 900 may be substantially the same as or similar to the EHA 100 described above, and consequently the above-description is equally applicable to the EHA 900 except as noted below.

In the EHA 900, a motor 902 provides a motive source to a reversible pump 904 that drives the pump 904 in one direction to pump fluid via a first fluid line 906 to a piston side 908 of the cylinder 910 to push a piston 912 in one direction and extend the rod 914 (e.g., up) and drives the pump 904 in the opposite direction to pump fluid via the second fluid line 916 to the rod side 918 of the cylinder 910 to retract the rod 914 (e.g., down). The motor 902 may drive the pump 904 to extend and/or retract the piston 912 and the rod 914 to a set pressure. As shown, each fluid line 906 and 916 may include a pilot-operated check valve 920 and 922, respectively, such as a spool valve, connected therein. In addition, one or more valves, such as respective relief valves 924 and 926 and TRV valves 928 and 930 may be fluidly connected to each fluid line 906 and 916.

To reduce pressure closing the extend-side pilot-operated check valve 920, the EHA 900 includes a fixed orifice restrictor 932. When a high load F, such as an external compressive load on a bed (e.g., bariatric hospital bed 800), is applied in compression as the pump 904 is providing flow to the rod side 918, the pilot-operated check valve 920 is opened. As fluid from the piston-side 908 of the cylinder 910 is forced back to a reservoir or tank 934, the fluid is controlled by flowing through the fixed orifice restrictor 932 to allow the pilot-operated check valve 920 to stay open consistently with the flow provided by the pump 904. By including the fixed orifice restrictor 932, the pilot-operated check valve 920 has stabilized performance and minimal to no noise or excessive vibration emitted.

As noted above, the fixed orifice restrictor 932 may be any suitable device, such as a fixed orifice size (e.g., orifice plate), needle valve, and/or any other bi-directional restricting feature. Accordingly, the fixed orifice restrictor can be tuned to reduce noise, vibration, and/or harshness (NVH).

According to an aspect of the disclosure, an electro-hydraulic actuator (EHA) comprises: a pump; an electric motor drivingly coupled to the pump; a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump; a check valve assembly arranged in a fluid line between the pump and the piston-side cylinder chamber; and a flow restrictor in the fluid line between the piston-side cylinder chamber and the check valve assembly.

Exemplary embodiments may include one or more of the following additional features, separately or in any combination.

In exemplary embodiment(s), wherein the flow restrictor is sized to maintain the check valve assembly in a fluid return mode without oscillation of a check valve member of the check valve assembly for fluid connection between the piston-side cylinder chamber and a fluid reservoir.

In exemplary embodiment(s), further comprising: a second fluid line between pump and the rod-side cylinder chamber; and a movable spool, wherein the spool moves in response to fluid pressure in the second fluid line when fluid flows from the pump to the rod-side cylinder chamber, wherein the spool is configured to move to activate the check valve member into the fluid return mode, and wherein the flow restrictor is further sized to limit return fluid pressure on check valve member from fluid flow between the piston-side cylinder chamber and the fluid reservoir to be below the fluid pressure in the second fluid line.

In exemplary embodiment(s), further comprising a second check valve assembly arranged in the second fluid line between the pump and the rod-side cylinder chamber, wherein the fluid pressure in the second fluid line activates a second check valve member of the second check valve assembly to maintain the second check valve assembly in a fluid supply mode to fluidly connect the rod-side cylinder chamber and the fluid reservoir.

In exemplary embodiment(s), wherein the flow restrictor is sized to maintain the check valve assembly in the fluid return mode while the second check valve assembly is in the fluid supply mode.

In exemplary embodiment(s), wherein the flow restrictor is a first orifice in the check valve assembly between the check valve member and the piston-side cylinder chamber, wherein the second check valve assembly includes a second orifice between the second check valve member and the piston-side cylinder chamber, wherein the first orifice has a first cross-sectional area and the second orifice has a second cross-sectional area that is larger than the first cross-sectional area.

In exemplary embodiment(s), wherein the first cross-sectional area of the first orifice is at least 23% smaller than the second orifice of the second check valve assembly.

In exemplary embodiment(s), wherein the check valve assembly includes a check seat and a retainer, wherein the flow restrictor is formed by at least one of the check seat or the retainer.

In exemplary embodiment(s), wherein the check seat and the retainer define an internal passage and a check valve member travels within the internal passage, wherein the flow restrictor defines a fluid path between the internal passage and an external surface of the at least one of the check seat or the retainer.

In exemplary embodiment(s), wherein the flow restrictor is formed by the check seat as a hole formed on the external surface of the check seat.

In exemplary embodiment(s), wherein the flow restrictor is formed at an interface between the check seat and the retainer.

In exemplary embodiment(s), wherein the flow restrictor is a slot formed on a surface of at least one of the check seat or the retainer at the interface between the check seat and the retainer.

In exemplary embodiment(s), wherein a shape and size of the flow restrictor is a function of at least one of an average operating speed of the electric motor, an average output of the pump, or a predetermined maximum compressive load applied against a rod of the piston and rod assembly during operation.

In exemplary embodiment(s), wherein the check valve assembly further includes a second flow restrictor in the fluid line between the piston-side cylinder chamber and the check valve assembly.

According to another aspect of the disclosure, a structure comprising a raisable and lowerable support and at least a first and a second electro-hydraulic actuators (EHA): the first and second EHA each comprises: a pump; an electric motor drivingly coupled to the pump; a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump; a check valve assembly arranged in a fluid line between the pump and the piston-side cylinder chamber; and a flow restrictor in the fluid line between the piston-side cylinder chamber and the check valve assembly, wherein the first EHA is positioned at a first end of the support, wherein the second EHA is positioned at a second end of the support that is opposite the first end.

Exemplary embodiments may include one or more of the following additional features, separately or in any combination.

In exemplary embodiment(s), wherein the structure is a bariatric hospital bed.

In exemplary embodiment(s), wherein the first EHA is adjacent to a foot of the hospital bed, wherein the second EHA is adjacent to a head of the hospital bed.

In exemplary embodiment(s), wherein an operating speed of moving the piston and rod assembly of the first EHA based on an operating speed of moving the second piston and rod assembly of the second EHA.

In exemplary embodiment(s), wherein the support is raisable or lowerable by powering the first and second EHAs simultaneously via pulse width modulation (PWM) control.

In exemplary embodiment(s), wherein each motor and each pump are bi-directional, and each piston-cylinder assembly is a two-way piston-cylinder assembly in which a second fluid line is fluidly connected to each rod-side cylinder chamber, whereby directing fluid to each piston-side cylinder chamber extends each rod of each piston and rod assembly, and whereby directing fluid to each rod-side cylinder chamber retracts each rod.

The term “or” as used herein is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something and is not intended to indicate a preference.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An electro-hydraulic actuator (EHA) comprising:
a pump;
an electric motor drivingly coupled to the pump;
a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump;
a check valve assembly arranged in a fluid line between the pump and the piston-side cylinder chamber; and
a flow restrictor in the fluid line between the piston-side cylinder chamber and the check valve assembly.

2. The EHA of claim 1, wherein the flow restrictor is sized to maintain the check valve assembly in a fluid return mode without oscillation of a check valve member of the check valve assembly for fluid connection between the piston-side cylinder chamber and a fluid reservoir.

3. The EHA of claim 2, further comprising:
a second fluid line between pump and the rod-side cylinder chamber; and
a movable spool, wherein the spool moves in response to fluid pressure in the second fluid line when fluid flows from the pump to the rod-side cylinder chamber, wherein the spool is configured to move to activate the check valve member into the fluid return mode, and wherein the flow restrictor is further sized to limit return fluid pressure on check valve member from fluid flow between the piston-side cylinder chamber and the fluid reservoir to be below the fluid pressure in the second fluid line.

4. The EHA of claim 3, further comprising a second check valve assembly arranged in the second fluid line between the pump and the rod-side cylinder chamber, wherein the fluid pressure in the second fluid line activates a second check valve member of the second check valve assembly to maintain the second check valve assembly in a fluid supply mode to fluidly connect the rod-side cylinder chamber and the fluid reservoir.

5. The EHA of claim 4, wherein the flow restrictor is sized to maintain the check valve assembly in the fluid return mode while the second check valve assembly is in the fluid supply mode.

6. The EHA of claim 4, wherein the flow restrictor is a first orifice in the check valve assembly between the check valve member and the piston-side cylinder chamber, wherein the second check valve assembly includes a second orifice between the second check valve member and the piston-side cylinder chamber, wherein the first orifice has a first cross-sectional area and the second orifice has a second cross-sectional area that is larger than the first cross-sectional area.

7. The EHA of claim 6, wherein the first cross-sectional area of the first orifice is at least 23% smaller than the second orifice of the second check valve assembly.

8. The EHA of claim 1, wherein the check valve assembly includes a check seat and a retainer, wherein the flow restrictor is formed by at least one of the check seat or the retainer.

9. The EHA of claim 8, wherein the check seat and the retainer define an internal passage and a check valve member travels within the internal passage, wherein the flow restrictor defines a fluid path between the internal passage and an external surface of the at least one of the check seat or the retainer.

10. The EHA of claim 9, wherein the flow restrictor is formed by the check seat as a hole formed on the external surface of the check seat.

11. The EHA of claim 9, wherein the flow restrictor is formed at an interface between the check seat and the retainer.

12. The EHA of claim 11, wherein the flow restrictor is a slot formed on a surface of at least one of the check seat or the retainer at the interface between the check seat and the retainer.

13. The EHA of claim 1, wherein a shape and size of the flow restrictor is a function of at least one of an average operating speed of the electric motor, an average output of the pump, or a predetermined maximum compressive load applied against a rod of the piston and rod assembly during operation.

14. The EHA of claim 1, wherein the check valve assembly further includes a second flow restrictor in the fluid line between the piston-side cylinder chamber and the check valve assembly.

15. A structure comprising a raisable and lowerable support and at least a first and a second electro-hydraulic actuators (EHA):
the first and second EHA each comprising:
a pump;
an electric motor drivingly coupled to the pump;
a piston-cylinder assembly having a piston and rod assembly axially movable within a cylinder, the cylinder having a piston-side cylinder chamber and a rod-side cylinder chamber that are each in fluid communication with the pump to effect movement of the piston and rod in response to fluid flow between the cylinder and the pump;
a check valve assembly arranged in a fluid line between the pump and the piston-side cylinder chamber; and
a flow restrictor in the fluid line between the piston-side cylinder chamber and the check valve assembly,
wherein the first EHA is positioned at a first end of the support, wherein the second EHA is positioned at a second end of the support that is opposite the first end.

16. The structure of claim 15, wherein the structure is a bariatric hospital bed.

17. The structure of claim 16, wherein the first EHA is adjacent to a foot of the hospital bed, wherein the second EHA is adjacent to a head of the hospital bed.

18. The structure of claim 15, wherein an operating speed of moving the piston and rod assembly of the first EHA based on an operating speed of moving the second piston and rod assembly of the second EHA.

19. The structure of claim 15, wherein the support is raisable or lowerable by powering the first and second EHAs simultaneously via pulse width modulation (PWM) control.

20. The structure of claim 15, wherein each motor and each pump are bi-directional, and each piston-cylinder assembly is a two-way piston-cylinder assembly in which a second fluid line is fluidly connected to each rod-side cylinder chamber, whereby directing fluid to each piston-side cylinder chamber extends each rod of each piston and rod assembly, and whereby directing fluid to each rod-side cylinder chamber retracts each rod.
